(19) United States
(12) Patent Application Publication
(10) Pub. No.: US 2019/0327934 A1
(43) Pub. Date: Oct. 31, 2019

(54) ANIMAL IDENTIFICATION DEVICE, METHOD FOR CONTROLLING ANIMAL IDENTIFICATION DEVICE AND RECORDING MEDIUM

(71) Applicant: SHARP KABUSHIKI KAISHA, Sakai City, Osaka (JP)

(72) Inventor: NOBUYUKI ASAHARA, Sakai City (JP)

(21) Appl. No.: 16/462,159

(22) PCT Filed: Aug. 25, 2017
(86) PCT No.: PCT/JP2017/030621

§ 371 Date: May 17, 2019

(30) Foreign Application Priority Data
Nov. 24, 2016 (JP) 2016-228226

(51) Int. Cl. A01K 11/00; A01K 29/00; A01K 27/00

(52) U.S. Cl. CPC A01K 11/006; A01K 27/001; A01K 29/005

(57) ABSTRACT

An embodiment of the present invention identifies an animal which has entered a predetermined region. An embodiment of the present invention includes an individual-identifying section (134) which identifies an animal that has entered an animal toilet (1), on the basis of at least one selected from: a body weight of a pet as measured when that pet was in the animal toilet; and identification information indicated by a signal whose strength at the predetermined region is greater than or equal to a threshold value, the signal being emitted from a transmission device worn by a pet.

### TECHNICAL FIELD

The present invention relates to: an animal identifying device which identifies, from among a plurality of animals, an animal which has entered a predetermined region; a method of controlling the animal identifying device; and a program.

### BACKGROUND ART

Recently, owners of animals such as pets have come to place importance on daily management of animal health. For example, in order to ascertain the health of a pet, it is important to measure, e.g., the body weight of the pet. Patent Document 1 discloses an automated body weight measurement system for a pet which is installed below a resting place for a pet. The system measures the weight of the resting place in both (i) a state where the pet is on the resting place and (ii) a state where the pet is not on the resting place. The system calculates the weight of the pet and then outputs the weight by displaying the weight. Patent Document 1 discloses that the system wirelessly reads the identification information of the pet, which is recorded in an RF tag worn by the pet, so as to identify the pet. The system displays the name of the identified pet along with the weight.

### CITATION LIST

### Patent Literature

[Patent Literature 1]

Japanese Patent Application Publication Tokukai No. 2007-330200 (Publication date: Dec. 27, 2007)

### SUMMARY OF INVENTION

### Technical Problem

However, the prior art as described above has the problem that, when a plurality of pets are in the vicinity of the body weight measurement system at the same time, it is difficult to identify which pet is on the scale. The present invention has been made in view of the above problem. An object of the present invention is to provide an animal identifying device capable of identifying, from among a plurality of pets, an animal which has entered a predetermined region.

### Solution to Problem

In order to solve the above problem, an animal identifying device in accordance with an aspect of the present invention includes: an identity-determining information acquiring section which acquires at least one selected from the following: information indicating a body weight of an animal among one or more animals, as measured when that animal was in a predetermined region; and identification information that is indicated by a signal whose strength at the predetermined region is greater than or equal to a threshold value, the signal being transmitted from one of one or more transmission devices respectively worn by the one or more animals; and an individual-identifying section which identifies a first animal among the one or more animals which first animal has entered the predetermined region, on the basis of the at least one selected from the information indicating the body weight and the identification information.

In order to solve the above problem, a method in accordance with an aspect of the present invention is a method of controlling an animal identifying device, the method including: an identity-determining information acquisition step of acquiring at least one selected from the following: information indicating a body weight of an animal among one or more animals, as measured when that animal was in a predetermined region; and identification information that is indicated by a signal whose strength at the predetermined region is greater than or equal to a threshold value, the signal being transmitted from one of one or more transmission devices respectively worn by the one or more animals; and an individual identification step of identifying a first animal among the one or more animals which first animal has entered the predetermined region, on the basis of the at least one selected from the information indicating the body weight and the identification information.

### Advantageous Effects of Invention

An aspect of the present invention makes it possible to identify, out of a plurality of animals, an animal which has entered a predetermined region.

### BRIEF DESCRIPTION OF DRAWINGS

FIG. 1 is a block diagram illustrating a configuration of main parts of a management system in accordance with Embodiment 1.

FIG. 2 is a diagram illustrating an overview of the management system in accordance with Embodiment 1.

(a) of FIG. 3 is a flowchart illustrating an example of processing carried out by an entry/exit determining section in accordance with Embodiment 1. (b) of FIG. 3 is a flowchart illustrating an example of processing carried out by an individual-identifying section in accordance with Embodiment 1.

FIG. 4 is a diagram showing examples of weights (body weights) indicated by information acquired by a weight acquiring section in accordance with Embodiment 1.

(a) to (c) of FIG. 5 are each a flowchart showing an example flow of individual identification processing carried out by the individual-identifying section in accordance with Embodiment 1.

FIG. 6 is a diagram illustrating an example of how the body-weight-based identification section in accordance with Embodiment 1 calculates body weight from weights detected by a scale.

(a) and (b) of FIG. 7 are each a diagram illustrating an example of strength of a signal received by an individual-identifying device from an ID information transmission device while a pet is in an animal toilet, in accordance with Embodiment 1.

(a) and (b) of FIG. 8 are each a diagram illustrating an example of strength of a signal received by the individual-identifying device from the ID information transmission device after a pet has exited the animal toilet and no pet is in the animal toilet, in accordance with Embodiment 1.

FIG. 9 is a block diagram illustrating a configuration of main parts of a management system in accordance with Embodiment 2 of the present invention.

FIG. 10 is a flowchart illustrating an example of processing carried out by an entry/exit determining section in accordance with Embodiment 2 of the present invention.

FIG. 11 is a diagram showing examples of sensor values detected by a proximity sensor in accordance with Embodiment 2 of the present invention.

FIG. 12 is a block diagram illustrating a configuration of main parts of a management system in accordance with Embodiment 3.

FIG. 13 is a flowchart illustrating an example of processing carried out by an individual-identifying section in accordance with Embodiment 3.

### DESCRIPTION OF EMBODIMENTS

### Embodiment 1

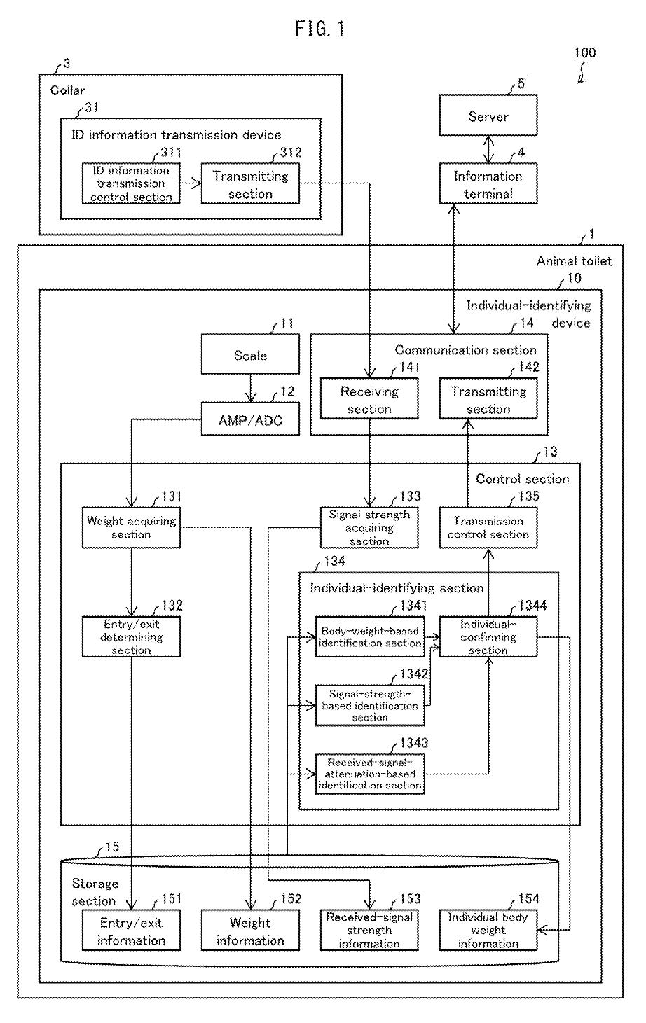

With reference to FIGS. 1 to 8, the following description will discuss in detail an embodiment of the present invention.

(Overview of Pet Management System 100)

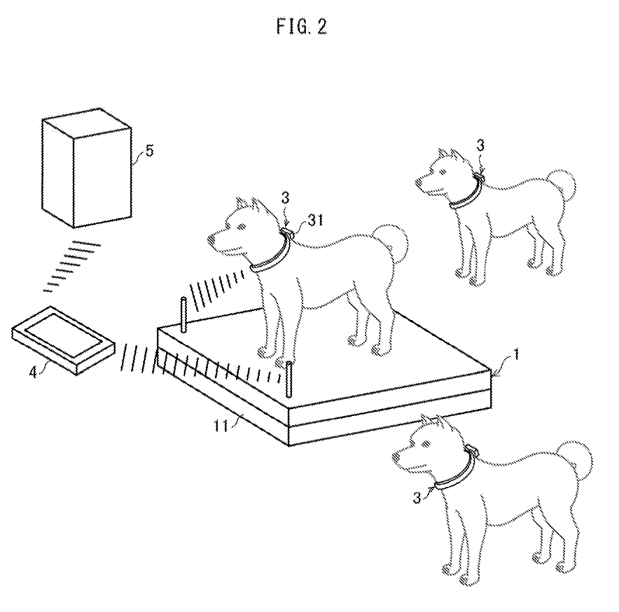

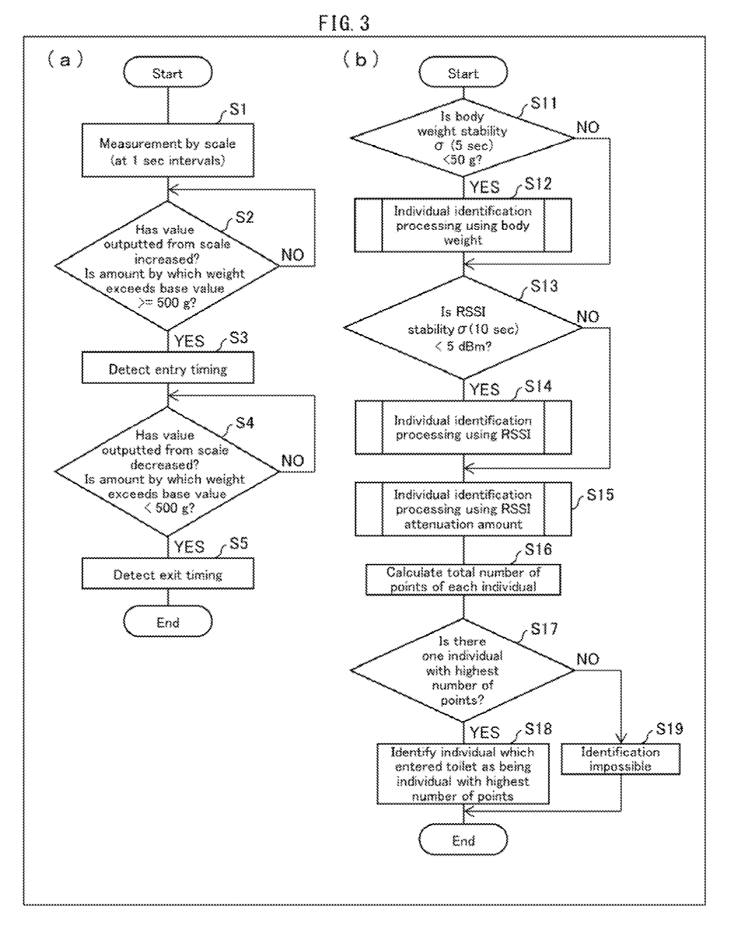

First, an overview of Embodiment 1 is discussed with reference to FIG. 2. FIG. 2 is a diagram illustrating an overview of a pet management system 100. The pet management system 100 includes an animal toilet 1 (a predetermined region), a collar 3, an information terminal 4, and a server 5. The animal toilet 1 includes a scale 11. An individual-identifying device (animal identifying device) 10 identifies, from among a plurality of pets, a pet which has entered the animal toilet 1. The individual-identifying device 10 identifies the pet with use of at least one selected from the following: a weight detected by the scale 11; and identification information that is indicated by a signal whose strength at the animal toilet 1 is greater than or equal to a threshold value. The signal is received from an ID information transmission device 31 which (i) is worn by a pet and (ii) sends out ID information. The body weight of the animal that has been identified is, for example, transmitted to the information terminal 4 and the server 5.

(Configuration of Pet Management System 100)

Discussed next, with reference to FIG. 1, are details of a configuration of the pet management system 100. FIG. 1 is a block diagram illustrating a configuration of main parts of the pet management system 100, which identifies, from among a plurality of pets, a pet which has entered the animal toilet (predetermined region) 1.

(Collar 3)

The collar 3 is worn by a pet. The collar 3 includes an ID information transmission device 31. The ID information transmission device 31 includes an ID information transmission control section 311 and a transmitting section 312. The ID information transmission control section 311 transmits, to the individual-identifying device 10 via the transmitting section 312, a signal indicating identification (ID) information of the pet which is wearing the collar 3. The transmitting section 312 transmits the signal to the individual-identifying device 10 with use of, for example, short range wireless communication (such as Bluetooth (registered trademark)).

(Animal Toilet 1)

In addition to serving as a pet toilet, the animal toilet 1 also measures the body weight of a pet. The animal toilet 1 includes the individual-identifying device 10. The individual-identifying device 10 may be configured to transmit measurement data, such as the body weight of a pet, to the information terminal 4 with use of, for example, short range wireless communication (such as Bluetooth). The information terminal 4 may be configured to display measurement data such as the received body weight of the pet. The information terminal 4 may be configured to cause the server 5 to store measurement data such as the received body weight of the pet. Examples of the information terminal 4 include a smartphone, a personal computer (PC), a personal digital assistant (PDA), and a tablet device. Examples of the server 5 include a cloud server.

(Individual-Identifying Device 10)

As illustrated in FIG. 1, the individual-identifying device 10 includes a scale 11, an amp (amplifier) and analog-to-digital converter (ADC) 12, a control section 13, a communication section 14, and a storage section 15.

(Scale 11)

The scale 11 detects a weight on the animal toilet 1 and transmits the detected value to a weight acquiring section 131. In other words, the scale 11 can be described as detecting entry/exit of a pet into/from the animal toilet 1. The scale 11 is, for example, a load cell. The scale 11 may transmit a detected value to a weight acquiring section 131 via the amp and ADC 12. The amp amplifies a received detected value. The ADC converts the detected value received as an analog signal into a digital signal.

(Control Section 13)

As illustrated in FIG. 1, the control section 13 includes the weight acquiring section 131, an entry/exit determining section (timing confirming section) 132, a signal strength acquiring section 133, an individual-identifying section 134, and a transmission control section 135.

(Weight Acquiring Section 131)

The weight acquiring section 131 acquires information indicating the weight on the animal toilet 1 by receiving a value detected by the scale 11. The weight acquiring section 131 transmits the information indicating the weight on the animal toilet 1 to the entry/exit determining section 132. The weight acquiring section 131 also updates weight information 152 which is stored in the storage section 15. The weight information 152 indicates a weight on the animal toilet 1 in association with a time of detection.

(Entry/Exit Determining Section 132; Flow of Processing Carried Out by Entry/Exit Determining Section 132)

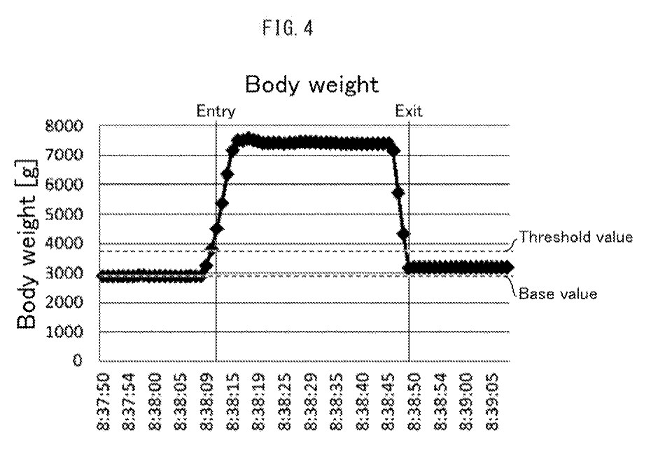

The entry/exit determining section 132 detects that a pet has entered the animal toilet 1, on the basis of a change in the weight on the animal toilet 1 as indicated by information acquired by the weight acquiring section 131. More specifically, the entry/exit determining section 132 confirms the timing of entry/exit of a pet into/from the animal toilet 1, on the basis of a change in the weight on the animal toilet 1. A flow of processing carried out by the entry/exit determining section 132 will be discussed here with reference to (a) of FIG. 3 and to FIG. 4. (a) of FIG. 3 is a flowchart illustrating an example of processing carried out by the entry/exit determining section 132. FIG. 4 is a diagram showing examples of weights (body weights) indicated by information acquired by the weight acquiring section 131.

As illustrated in (a) of FIG. 3, the entry/exit determining section 132 acquires information indicating the weight at predetermined intervals (e.g., 1 second intervals) (measurement by scale) (S1). As illustrated in FIG. 4, the entry/exit determining section 132 uses, as a base value, a weight as indicated by information acquired while no pet is in the animal toilet 1. Subsequently, the entry/exit determining section 132 determines whether or not the weight (output value of the scale 11) indicated by the received information has increased. More specifically, the entry/exit determining section 132 determines whether or not an amount by which the weight indicated by the received information exceeds the base value is greater than or equal to 500 g (threshold value) (S2). In a case where, as illustrated in FIG. 4, the amount by which the weight indicated by the information received by the entry/exit determining section 132 exceeds the base value is greater than or equal to 500 g (threshold value)(“YES” in S2), the entry/exit determining section 132 confirms the time point at which the amount by which the weight exceeds the base value became greater than or equal to 500 g (threshold value) as being the timing of when a pet entered the animal toilet 1 (detection of entry timing)(S3). Subsequently, the entry/exit determining section 132 determines whether or not the weight indicated by received information has decreased. Specifically, the entry/exit determining section 132 determines whether or not an amount by which the weight indicated by received information is exceeds the base value is less than 500 g (threshold value) (S4). In a case where, as illustrated in FIG. 4, the amount by which the weight indicated by information received by the entry/exit determining section 132 exceeds the base value is less than 500 g (threshold value)(“YES” in S4), the entry/exit determining section 132 confirms a time point at which the amount by which the weight exceeded the base value the became less than 500 g (threshold value) as being the timing of when the pet exited the animal toilet 1 (detection of exit timing)(S5). In a case where, in S2, the amount by which the weight indicated by received information is increased over the base value is less than 500 g (“NO” in S2), processing returns to S2. In a case where, in S4, the amount by which the weight indicated by received information exceeds the base value is greater than or equal to 500 g (“NO” in S4), the processing returns to S4. After the entry/exit determining section 132 confirms the timing of an entry or exit, the entry/exit determining section 132 updates entry/exit information 151 stored in the storage section 15. The entry/exit information 151 is information indicating the timing (time) of pet entry/exit into/from the animal toilet 1.

The above explanation uses an example in which 500 g is the threshold value of the amount by which a weight exceeds the base value, which threshold value is used for determining the timing of pet entry and exit into/from the animal toilet 1. Note, however, that this threshold value may be any value and is not particularly limited.

(Signal Strength Acquiring Section 133)

The signal strength acquiring section 133 acquires (i) information indicating the strength, at the animal toilet 1, of a signal transmitted from an ID information transmission device 31 worn by a pet, and (ii) identification information indicated by that signal.

The communication section 14 (described later) may include a signal strength detecting section (not shown) which detects the strength of the signal received from the ID information transmission device 31. The signal strength acquiring section 133 receives information indicating the strength of the signal received from the communication section 14. The signal strength acquiring section 133 updates received-signal strength information 153, which is stored in the storage section 15. The received-signal strength information 153 is information which indicates the strength of a respective signal received from each ID information transmission device 31, in association with a time of reception.

(Individual-Identifying Section 134)

The individual-identifying section 134 identifies an animal which has entered the animal toilet 1, on the basis of at least one selected from the following: a body weight of an animal as measured when that animal was in a predetermined region; and identification information that is indicated by a signal whose strength at the predetermined region is greater than or equal to a threshold value, the signal being transmitted from a transmission device worn by an animal. The individual-identifying section 134 includes a body-weight-based identification section (identity-determining information acquiring section) 1341, a signal-strength-based identification section (identity-determining information acquiring section) 1342, a received-signal-attenuation-based identification section (identity-determining information acquiring section) 1343 and an individual-confirming section 1344.

(Body-Weight-Based Identification Section 1341, Signal-Strength-Based Identification Section 1342, Received-Signal-Attenuation-Based Identification Section 1343, Individual-Confirming Section 1344)

The body-weight-based identification section 1341 acquires information indicating a weight on the animal toilet 1 as detected in a period during which a pet is in the animal toilet 1 (i.e., the measured body weight of the pet) and identifies the pet in the animal toilet 1 with use of the weight. The body-weight-based identification section 1341 also confirms the body weight of the pet that has entered the animal toilet 1 and transmits information indicating the confirmed body weight to the individual-confirming section 1344.

The signal-strength-based identification section 1342 acquires identification information that is indicated by a signal whose strength at the animal toilet 1 is greater than or equal to a threshold value (first threshold value), the signal being transmitted from an ID information transmission device 31 worn by a pet. The signal-strength-based identification section 1342 then identifies the animal in the animal toilet 1 on the basis of the identification information.

The received-signal-attenuation-based identification section 1343 acquires (i) information indicating the strength of a signal at the animal toilet 1 as observed after a pet exits or before the pet enters the animal toilet 1, the signal being transmitted from an ID information transmission device 31 worn by that pet, and (ii) identification information that is indicated by the signal. The signal-strength-based identification section 1342 identifies an animal which has entered the animal toilet 1 on the basis of identification information that is indicated by a signal whose strength, at the animal toilet 1, is attenuated by an amount greater than or equal to a threshold value (fourth threshold value), the signal being transmitted from an ID information transmission device 31 worn by a pet. The received-signal-attenuation-based identification section 1343 may identify an animal which has entered the animal toilet 1 on the basis of identification information that is indicated by a signal whose strength, at the animal toilet 1, is increased by an amount greater than or equal to a threshold value (third threshold value), the signal being transmitted from an ID information transmission device 31 worn by a pet. In other words, the received-signal-attenuation-based identification section 1343 identifies an animal which has entered the animal toilet 1 on the basis of identification information that is indicated by a signal whose strength at the animal toilet 1 differs, between a period in which an animal is in the animal toilet 1 and a period in which an animal is not in the animal toilet 1, by an amount greater than or equal to a threshold value, the signal being transmitted from an ID information transmission device 31.

The individual-confirming section 1344 identifies an animal which has entered the animal toilet 1 on the basis of an aggregation of the identification results from the body-weight-based identification section 1341, the signal-strength-based identification section 1342, and the received-signal-attenuation-based identification section 1343. A flow of processing carried out by the individual-identifying section 134 will be discussed in detail below.

(Flow of Processing Carried Out by Individual-Identifying Section 134)

With reference to (b) of FIG. 3, the following description will discuss a flow of processing carried out by the individual-identifying section 134. (b) of FIG. 3 is a flowchart illustrating an example of processing carried out by the individual-identifying section 134. Once the entry/exit determining section 132 has confirmed the timing of pet entry/exit into/from the animal toilet 1, the individual-identifying section 134 commences processing to identify an individual. For example, the entry/exit determining section 132 may be configured to transmit to the individual-identifying section 134 (in particular, to the body-weight-based identification section 1341, the signal-strength-based identification section 1342, and the received-signal-attenuation-based identification section 1343) notification that the entry/exit determining section 132 has confirmed the timing of pet entry/exit into/from the animal toilet 1.

(Flow of Individual Identification Processing Using Body Weight)

As illustrated in (b) of FIG. 3, the body-weight-based identification section 1341 reads out the entry/exit information 151 and the weight information 152 stored in the storage section 15. While a pet is in the animal toilet 1, the body-weight-based identification section 1341 determines whether or not a change in weight during a predetermined period (e.g., 5 seconds) is within a predetermined range (e.g., within a range of 50 g) (determination of stability of detected weight) (S11). In a case where, while the pet is in the animal toilet 1, a change in weight during the predetermined period is within the predetermined range (“YES” in S11), the individual-identifying section 134 carries out individual identification processing with use of the body weight (S12). In a case where, while the pet is in the animal toilet 1, the change in weight during the predetermined period is outside the predetermined range (“NO” in S11), the processing proceeds to S13 (described later).

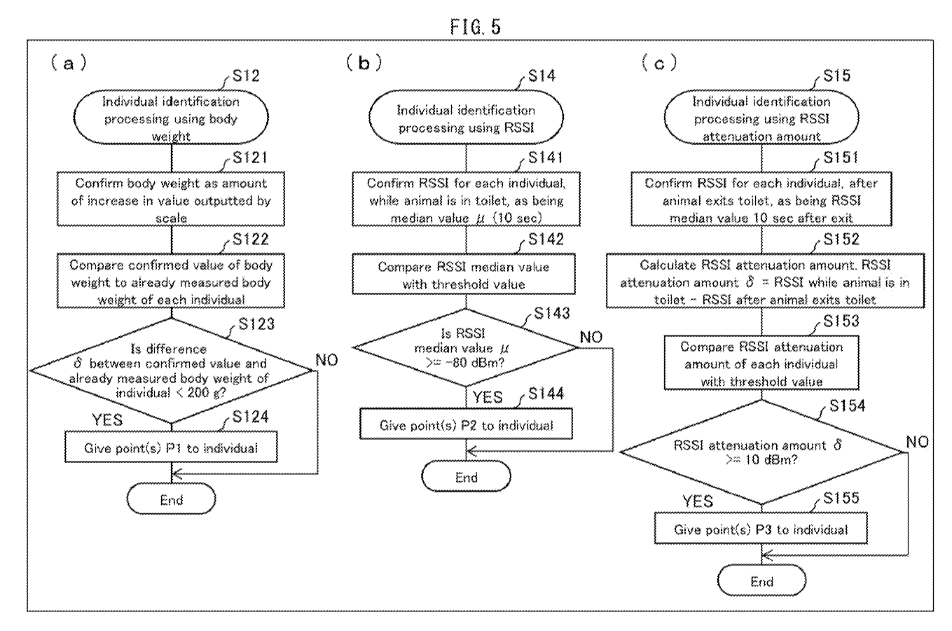

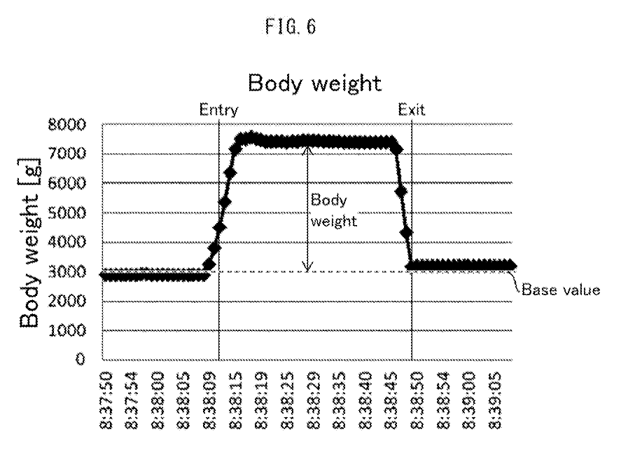

With reference to (a) of FIG. 5 and to FIG. 6, the following description will discuss details of individual identification processing which uses body weight (S12). FIG. 5 (a) is a flowchart illustrating an example of a flow of individual identification processing using body weight, as carried out by the individual-identifying section 134. FIG. 6 is a diagram illustrating an example of how the body-weight-based identification section 1341 calculates body weight from weights detected by the scale 11. As illustrated in FIG. 5 (a), the body-weight-based identification section 1341 confirms the body weight of a pet in the animal toilet 1 (S121: identity-determining information acquisition step). More specifically, as illustrated in FIG. 6, the body-weight-based identification section 1341 confirms the body weight of the pet in the animal toilet 1 by calculating the difference between (i) a weight as measured when the weight is stable, as described above and (ii) a base value (i.e., by calculating an amount by which the weight exceeds the base value). Note that the method of calculating the base value is not described here, as it has been described above with reference to the entry/exit determining section 132 and S1 of the processing carried out by the entry/exit determining section 132. Next, the body-weight-based identification section 1341 reads out, from the storage section 15, individual body weight information 154 which indicates the body weight of each of a plurality of pets. The body-weight-based identification section 1341 compares (i) the body weight of the pet who has entered the animal toilet 1, as confirmed in S121, with (ii) the body weights of each of the plurality of pets as recorded in the individual body weight information 154 (S122). Specifically, the body-weight-based identification section 1341 determines whether or not the difference between (i) the body weight of each pet as recorded in the individual body weight information 154 and (ii) the body weight of the pet as confirmed in S121 is within a predetermined range (e.g., less than 200 g) (S123). Then, the body-weight-based identification section 1341 transmits the identification result (determination result) to the individual-confirming section 1344. In a case where the difference between (i) the body weight of a pet as recorded in the individual body weight information 154 and (ii) the body weight of the pet as determined in S121 and is within the predetermined range (e.g., less than 200 g) (“YES” in S123), the individual-confirming section 1344 gives point(s) P1 to the corresponding pet (S124). In a case where the difference between (i) the body weight of a pet as recorded in the individual body weight information 154 and (ii) the body weight of the pet as determined in S121 and is not within the predetermined range (“No” in S123), the individual-confirming section 1344 does not give points to the corresponding pet.

(Flow of Individual Identification Processing Using Identification Information Indicated by Signal Whose Strength is Above Greater than or Equal to Threshold Value)

As illustrated in (b) of FIG. 3, after S12, the signal-strength-based identification section 1342 reads out the entry/exit information 151 and the received-signal strength information 153 stored in the storage section 15. While a pet is in the animal toilet 1, the signal-strength-based identification section 1342 determines, for a respective signal received from each ID information transmission device 31, whether or not a change in the received signal strength (RSSI) during a predetermined period (e.g., 10 seconds) is within a predetermined range (e.g., within a range of 5 dBm)(determination of received signal stability)(S13). In a case where, while a pet is in the animal toilet 1, the change in the strength of a received signal from an ID information transmission device 31 during the predetermined period is within the predetermined range (“YES” in S13), the individual-identifying section 134 carries out, for the pet wearing that ID information transmission device 31, individual identification processing with use of identification information that is indicated by a signal whose strength is greater than or equal to the threshold value (S14). In a case where, while a pet is in the animal toilet 1, the change in the strength of a received signal from an ID information transmission device 31 during the predetermined period is not within the predetermined range (“NO” in S11), the individual-identifying section 134 does not carry out, for the pet wearing that ID information transmission device 31, individual identification processing with use of identification information that is indicated by a signal whose strength is greater than or equal to the threshold value. In such a case, the processing then proceeds to S15 (described later).

With reference to (b) of FIG. 5 and to FIG. 7, the following description will discuss details of individual identification processing using identification information indicated by a signal whose strength is greater than or equal to a threshold value (individual identification processing using an RSSI) (S14). (b) of FIG. 5 is a flowchart illustrating an example flow of individual identification processing carried out by the individual-identifying section 134 with use identification information indicated by a signal whose strength is greater than or equal to a threshold value. As illustrated in (b) of FIG. 5, the signal-strength-based identification section 1342 confirms the strength of signals received from respective ID information transmission devices 31 worn by pets, specifically the signals received while a pet is in the animal toilet 1. FIG. 7 is a diagram illustrating examples of strength of signals received by the individual-identifying device 10 from ID information transmission devices 31 while a pet is in the animal toilet 1. The signal-strength-based identification section 1342 confirms the strength of a respective signal received from each ID information transmission device 31 while a pet is in the animal toilet 1, by calculating a median value of the strength of each received signal as measured during a certain period (e.g., 10 seconds) (S141: identity-determining information acquisition step). The certain period may be, for example, a period that includes the time point at which the strength of the received signal has become stable. RA1 and RB1 in (a) and (b) of FIG. 7 indicate the strengths of received signals at the respective time points at which the strength of each received signal became stable. Subsequently, the signal-strength-based identification section 1342 compares (i) the median value of the strength of a respective signal received from each ID information transmission device 31, as confirmed in S141 (ii) with the threshold value (first threshold value) (S142). More specifically, the signal-strength-based identification section 1342 determines, for each signal, whether or not the median value of the strength thereof, as confirmed in S141, is greater than or equal to the threshold value (e.g., −80 dBm) (S143). The signal-strength-based identification section 1342 then transmits the identification result (determination result) to the individual-confirming section 1344. In a case where the median value of the strength of a signal is greater than or equal to the threshold value (“YES” in S143), the individual-confirming section 1344 gives point(s) P2 to the pet corresponding to the identification information indicated by that signal (S144). For example, the signal strength RSSI A in (a) of FIG. 7 has a median value which is greater than or equal to the threshold value. In a case where the median value of the strength of a signal is less than the threshold value (“NO” in S143), the individual-confirming section 1344 does not give points to the pet corresponding to the identification information indicated by that signal. For example, the signal strength RSSI_B in (b) of FIG. 7 has a median value which is less than the threshold value.

(Flow of Individual Identification Processing Using Identification Information Indicated by a Signal Whose Strength has been Attenuated by an Amount Greater than or Equal to a Threshold Value)

As illustrated in (b) of FIG. 3, after S14 the individual-identifying section 134 carries out individual identification processing which uses identification information indicated by a signal whose strength has been attenuated by an amount greater than or equal to a threshold value (individual identification processing using RSSI attenuation amount) (S15). The following description will discuss details of this processing (S15) with reference to (c) of FIG. 5 and to FIG. 8. (c) of FIG. 5 is a flowchart illustrating an example flow of individual identification processing, carried out by the individual-identifying section 134 with use identification information indicated by a signal whose strength has been attenuated by an amount greater than or equal to a threshold value. As illustrated in (c) of FIG. 5, for a respective signal received from each ID information transmission device 31, the received-signal-attenuation-based identification section 1343 confirms the strength of that signal at a time point when a predetermined period has elapsed since a pet has exited the animal toilet 1 (for example, at a time point 10 seconds after the pet has exited). FIG. 8 is a diagram illustrating examples of strength of signals received by the individual-identifying device 10 from ID information transmission devices 31 after a pet has exited the animal toilet 1 and no pet is in the animal toilet 1. As illustrated in (a) and (b) of FIG. 8, for a respective signal received from each ID information transmission device 31, the received-signal-attenuation-based identification section 1343 calculates a median value of the strength of that signal as observed in a period starting at time point at which a predetermined period has elapsed since a pet has exited the animal toilet 1. In this way, the received-signal-attenuation-based identification section 1343 confirms the strength of the respective signal from each ID information transmission device 31 after a pet has exited the animal toilet 1 (S151). RA2 and RB2 in FIGS. 8 (a) and (b) indicate the strengths of signals received from ID information transmission devices 31 after a pet has exited the animal toilet 1. Next, for a respective signal received from each ID information transmission device 31, the received-signal-attenuation-based identification section 1343 calculates the difference between (i) signal strength as observed while the pet was in the animal toilet 1, as confirmed in S141 and (ii) signal strength as observed after the pet has exited the animal toilet 1, as confirmed in S151. In this way, the received-signal-attenuation-based identification section 1343 calculates an amount by which the respective signal from each ID information transmission device 31 has been attenuated (S152: identity-determining information acquisition step). Next, for a respective signal received from each ID information transmission device 31, the received-signal-attenuation-based identification section 1343 compares the amount of attenuation of that respective signal, as calculated in S152, with a threshold value (fourth threshold value) (S153). More specifically, for a respective signal received from each ID information transmission device 31, the received-signal-attenuation-based identification section 1343 determines whether or not the amount of attenuation of that respective signal, as calculated in S153, is greater than or equal to the threshold value (e.g., 10 dBm) (S154). The received-signal-attenuation-based identification section 1343 transmits the identification result (determination result) to the individual-confirming section 1344. In a case where the amount of attenuation of a signal received from an ID information transmission device 31, as calculated in S153, is greater than or equal to the threshold value (“YES” in S154), the individual-confirming section 1344 gives point(s) P3 to the pet corresponding to the identification information indicated by that signal (S155). For example, the received signal strength RSSI A in (a) of FIG. 8 has been attenuated by an amount that is greater than or equal to the threshold value. In a case where the amount of attenuation of a signal received from an ID information transmission device 31, as calculated in S153, is less than the threshold value (“NO” in S154), the individual-confirming section 1344 does not give the point(s) P3 to the pet corresponding to the identification information indicated by that signal. For example, the signal strength RSSI B shown in (b) of FIG. 8 is attenuated by an amount, as calculated in S153, which is less than the threshold value. Next, the individual-confirming section 1344 calculates the respective total number of points for each pet (S16), and determines whether or not there is one pet having the highest total number of points (S17). In a case where there is one pet having the highest total number of points (“YES” in S17), the individual-confirming section 1344 determines that the pet having the highest number of points is the pet which has entered the animal toilet 1 (S18: individual identification step). After confirming the pet that has entered the animal toilet 1, the individual-confirming section 1344 updates a body weight indicated by the individual body weight information 154 in the storage section 15. The individual-confirming section 1344 may be configured to transmit, to the transmission control section 135, information indicating the confirmed individual and information indicating the body weight of the confirmed individual. In a case where there is not one single pet having the highest total number of points (“NO” in S17), the individual-confirming section 1344 determines that the pet which has entered the animal toilet 1 cannot be identified (S19).

The above explanation involved an example in which received-signal-attenuation-based identification section 1343 identifies a pet which has entered the animal toilet 1, with use of identification information that is indicated by a signal whose strength, at the animal toilet 1, has been attenuated by an amount greater than or equal to the fourth threshold value, the signal being transmitted from an ID information transmission device 31 worn by a pet. In another example, the received-signal-attenuation-based identification section 1343 may identify a pet which has entered the animal toilet 1 with use of identification information that is indicated by a signal whose strength, at the animal toilet 1, has been increased by an amount greater than or equal to a third threshold value, the signal being transmitted from an ID information transmission device 31 worn by an animal. More specifically, in such a configuration, the received-signal-attenuation-based identification section 1343 compares (i) an amount by which a strength of a signal, as observed while a pet is in animal toilet 1, has increased over the strength of that signal as observed before the pet entered the animal toilet 1, and (ii) a threshold value.

Furthermore, discussed above in Embodiment 1 is a configuration in which the individual-identifying section 134 confirms a pet which has entered the animal toilet 1 in accordance with the identification results of (i) individual identification which uses body weight, (ii) individual identification which uses identification information indicated by a signal whose strength is greater than or equal to a threshold value, and (iii) individual identification which uses identification information indicated by a signal whose strength has been attenuated by an amount greater than or equal to a threshold value. Note that the individual-identifying section 134 may, for example, be configured to determine the pet that has entered the animal toilet 1 in accordance with the identification result of the only one of the above types of individual identification. Alternatively, the individual-identifying section 134 may be configured to determine the pet that has entered the animal toilet 1 in accordance with the identification results of two of the above types of individual identification.

(Transmission Control Section 135)

The transmission control section 135 controls transmission of data to an external device. In Embodiment 1 in particular, the transmission control section 135 receives, from the individual-confirming section 1344, information indicating the confirmed pet and the body weight of that pet, and then transmits the information to the information terminal 4 via the communication section 14.

(Communication Section 14)

The communication section 14 communicates with an external device(s). In particular, in Embodiment 1, the communication section 14 communicates with the information terminal 4 and the ID information transmission device 31. The communication section 14 includes a receiving section 141 which receives data from an external device(s) and a transmitting section 142 which transmits data to an external device(s). In particular, in Embodiment 1, the receiving section 141 receives a signal indicating the identification information of a pet from the ID information transmission device 31 via short range wireless communication.

(Storage Section 15)

The storage section 15 stores the entry/exit information 151, the weight information 152, the received-signal strength information 153, and the individual body weight information 154. The storage section 15 also stores threshold values which, for the purpose of identification, are referred to by, for example, the body-weight-based identification section 1341, the signal-strength-based identification section 1342, and the received-signal-attenuation-based identification section 1343. The server 5 or the information terminal 4 may be configured to store the entry/exit information 151, the weight information 152, the received-signal strength information 153, and the individual body weight information 154. In such a case, the individual-identifying section 134 may be configured to receive necessary information as appropriate via the receiving section 141.

### Embodiment 2

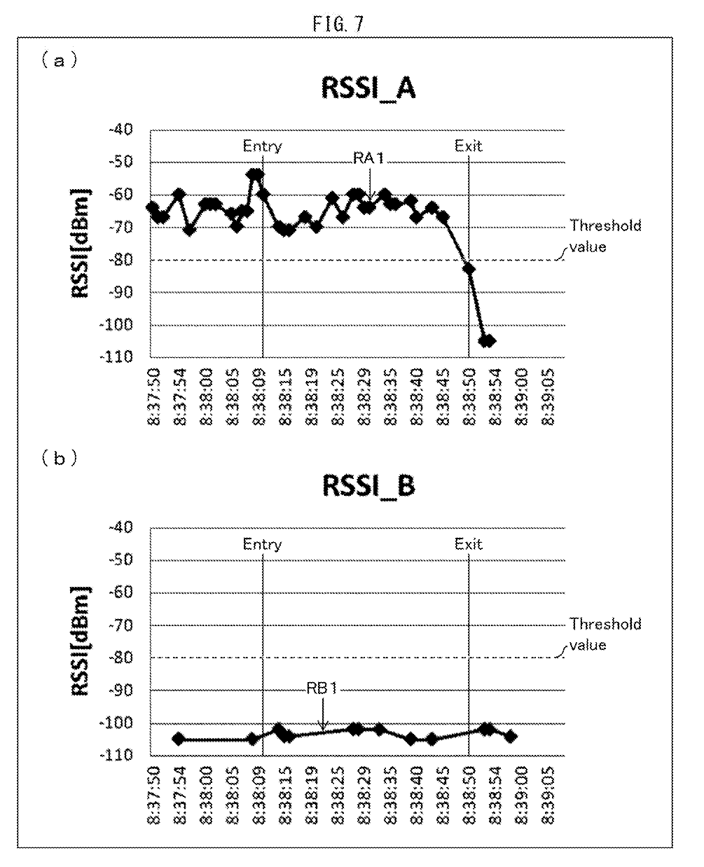

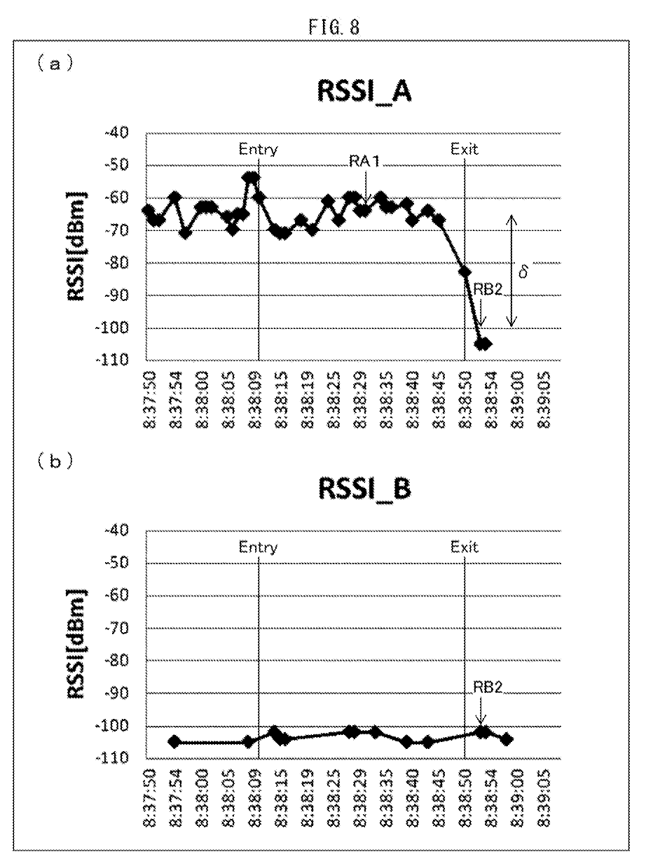

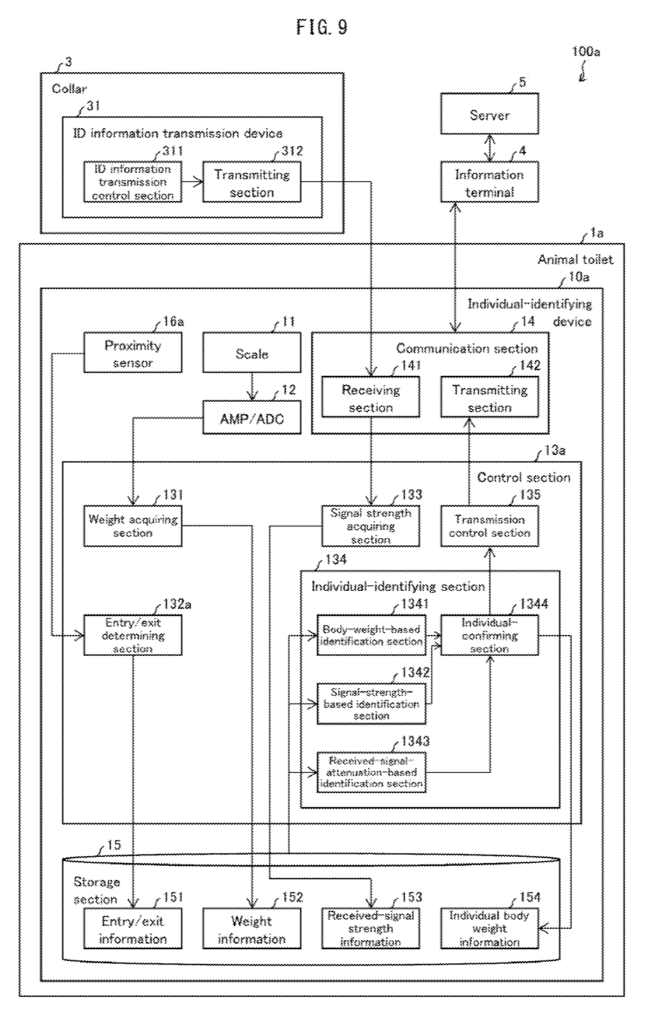

With reference to FIGS. 9 to 11, the following description will discuss another embodiment of the present invention. For convenience of explanation, the same reference numerals are given to members having functions identical with those described in the above embodiment, and descriptions of such members are omitted.

An animal toilet 1a according to Embodiment 2 includes an individual-identifying device 10a instead of the individual-identifying device 10 described in Embodiment 1. The individual-identifying device 10a confirms the timing of when a pet enters/exits an animal toilet 1a with use of detection values (output) from a proximity sensor 16a.

(Configuration of Pet Management System 100a)

The following description will discuss a configuration of a pet management system 100a in accordance with Embodiment 2. FIG. 9 is a block diagram illustrating a configuration of main parts of the pet management system 100a in accordance with Embodiment 2, which identifies, from among a plurality of pets, a pet which has entered a predetermined region. As illustrated in FIG. 9, the pet management system 100a includes an animal toilet 1a, a collar 3, an information terminal 4, and a server 5.

(Individual-Identifying Device 10a)

As illustrated in FIG. 9, the individual-identifying device 10a includes a scale 11, an amp and ADC 12, a control section 13a, a communication section 14, a storage section 15, and a proximity sensor 16a. The scale 11, the amp and ADC 12, the communication section 14, and the storage section 15 have been described in Embodiment 1, and descriptions of such are therefore omitted here. The proximity sensor 16a is provided so as to be able to detect an animal in the animal toilet 1a. In particular, in Embodiment 2, the proximity sensor 16a detects a pet in proximity to the animal toilet 1a. The proximity sensor 16a transmits a detected value to an entry/exit determining section 132a. The control section 13a includes an entry/exit determining section 132a instead of the entry/exit determining section 132 described in Embodiment 1. Except for this difference, the control section 13a configured similarly to the control section 13.

(Entry/Exit Determining Section 132a; Flow of Processing Carried Out by Entry/Exit Determining Section 132a)

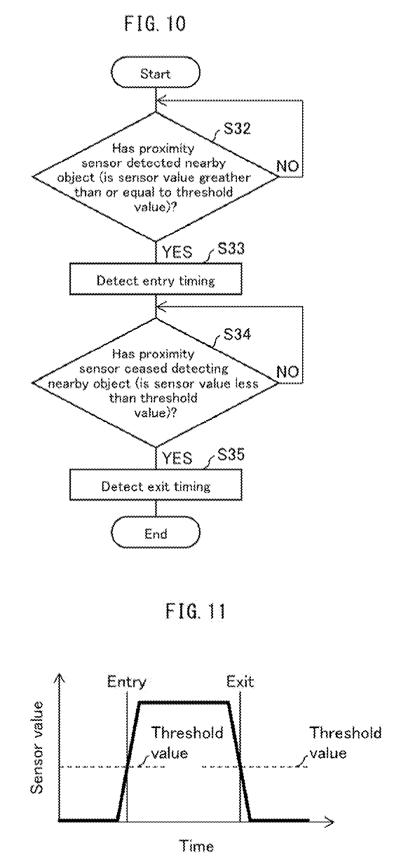

The entry/exit determining section 132a detects that a pet has entered the animal toilet 1, on the basis of a detected value from the proximity sensor 16a. Specifically, the entry/exit determining section 132a confirms the timing of when a pet has entered/exited the animal toilet 1 with use of a detected value from the proximity sensor 16a. A flow of processing carried out by the entry/exit determining section 132a will be described here with reference to FIGS. 10 and 11. FIG. 10 is a flowchart illustrating an example of processing carried out by the entry/exit determining section 132a. FIG. 11 is a diagram illustrating examples of detected values (sensor values) as detected by the proximity sensor 16a.

As illustrated in FIG. 10, the entry/exit determining section 132a determines whether or not the proximity sensor 16a has detected a nearby object. Specifically, the entry/exit determining section 132a determines whether or not a sensor value received from the proximity sensor 16a is greater than or equal to a threshold value (S32). As illustrated in FIG. 11, in a case where the received sensor value is greater than or equal to the threshold value (“YES” in S32), the entry/exit determining section 132a confirms a time point at which the received sensor value became greater than or equal to the threshold value as being the timing of when a pet entered the animal toilet 1a (entry timing detection) (S33). Next, the entry/exit determining section 132a determines whether or not the proximity sensor 16a has ceased detecting a nearby object. Specifically, the entry/exit determining section 132a determines whether or not a sensor value received from the proximity sensor 16a is less than the threshold value (S34). As illustrated in FIG. 11, in a case where a received sensor value is less than threshold value (“YES” in S34), the entry/exit determining section 132a confirms a time point at which the received sensor value became less than the threshold value as being the timing of when the pet exited the animal toilet 1a (exit timing detection) (S35). In a case where, in S32, the received sensor value is less than the threshold value (“NO” in S32), the processing returns to S32. In a case where, in S34, the received sensor value is greater than or equal to the threshold value (“NO” in S34), the processing returns to S34. After confirming the timing of entry/exit, the entry/exit determining section 132a updates the entry/exit information 151 stored in the storage section 15. After confirming the timing of entry/exit, the entry/exit determining section 132a transmits, to the individual-identifying section 134, notification that the timing of entry/exit has been confirmed.

Note that, instead of using a detected value from the proximity sensor 16a, the entry/exit determining section 132a may be configured to detect that a pet has entered the animal toilet 1 on the basis of the strength, at the animal toilet 1, of a signal transmitted by an ID information transmission device 31.

### Embodiment 3

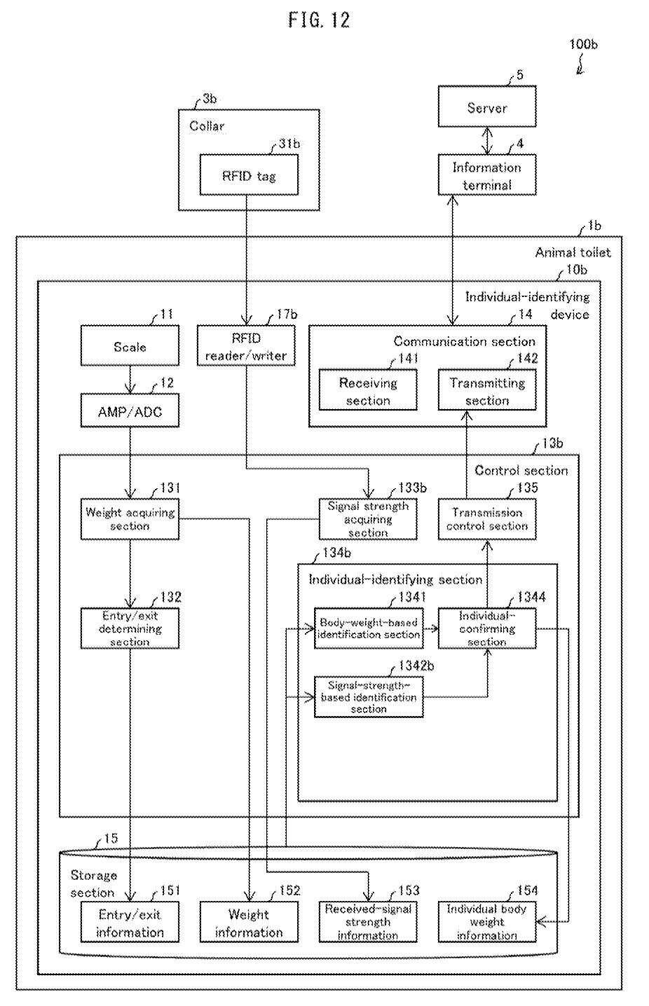

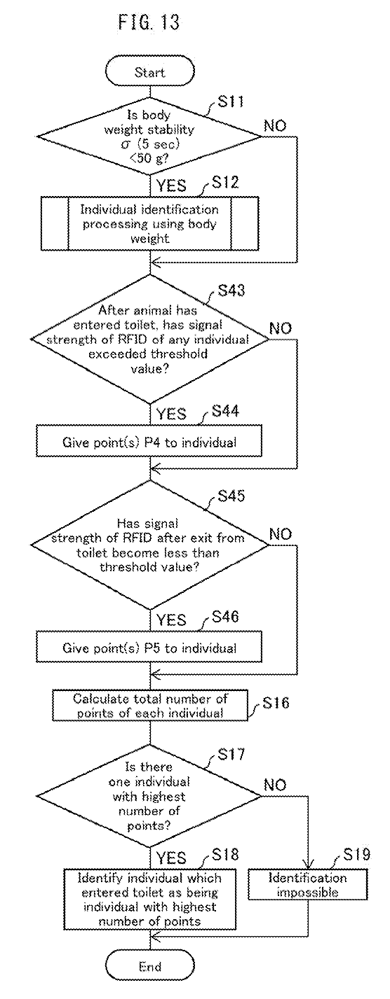

With reference to FIGS. 12 and 13, the following description will discuss another embodiment of the present invention. For convenience of explanation, the same reference numerals are given to members having functions identical with those described in the above embodiments, and descriptions of such members are omitted.

A collar 3b in accordance with Embodiment 3 includes a radio frequency identifier (RFID) tag 31b which sends out ID information of a pet. A pet management system 100b includes an individual-identifying device 10b. The individual-identifying device 10b identifies, from among a plurality of pets, a pet which has entered an animal toilet 1b, with use of at least one selected from the following: a weight on the animal toilet 1b, as indicated by information acquired by a weight acquiring section 131; and a strength of a signal received from the RFID tag 31b.

(Configuration of Pet Management System 100b)

The following description will discuss a configuration of the pet management system 100b in accordance with Embodiment 3. FIG. 12 is a block diagram illustrating a configuration of main parts of the pet management system 100b in accordance with Embodiment 3, which identifies, from among a plurality of pets, a pet which has entered the animal toilet 1b. As illustrated in FIG. 12, the pet management system 100b includes the animal toilet 1b, the collar 3b, an information terminal 4, and a server 5.

(Collar 3b)

As described above, the collar 3b includes the RFID tag 31b. For each pet wearing a collar 3b, the RFID tag 31b transmits, to the individual-identifying device 10b, a signal containing identification (ID) information of that pet.

(Individual-Identifying Device 10b)

As illustrated in FIG. 12, the individual-identifying device 10b includes a scale 11, an amp and ADC 12, a control section 13b, a communication section 14, a storage section 15, and an RFID reader/writer 17b. The scale 11, the amp and ADC 12, the communication section 14, and the storage section 15 have been described in Embodiment 1, and descriptions of such are therefore omitted here. The RFID reader/writer 17b receives a signal transmitted by the RFID tag 31b. The RFID reader/writer 17b also detects the strength of the signal received from the RFID tag 31b.

The control section 13b includes a signal strength acquiring section 133b and an individual-identifying section 134b, instead of the signal strength acquiring section 133 and the individual-identifying section 134 described in Embodiment 1. The signal strength acquiring section 133b receives (i) information indicating the strength of a signal detected by the RFID reader/writer 17b and (ii) identification information indicated by that signal. The signal strength acquiring section 133b updates received-signal strength information 153, which (i) is stored in the storage section 15 and (ii) indicates the strength of signals respectively received from each RFID tag 31b in association with a time of reception. The individual-identifying section 134b has a signal-strength-based identification section 1342b instead of the signal-strength-based identification section 1342 described in Embodiment 1.

(Flow of Individual Identification Processing Carried Out by Individual-Identifying Section 134b)

With reference to FIG. 13, the following description will discuss a flow of processing carried out by the individual-identifying section 134b. FIG. 13 is a flowchart illustrating an example of processing carried out by the individual-identifying section 134b. After the processing of S11 and S12 described in Embodiment 1, the signal-strength-based identification section 1342b reads out the entry/exit information 151 and received-signal strength information 153 stored in the storage section 15. The signal-strength-based identification section 1342b determines whether or not the strength of a respective signal received from each RFID tag 31b has exceeded a predetermined threshold value while a pet is in the animal toilet 1b (S43). The signal-strength-based identification section 1342b then transmits an identification result (determination result) to the individual-confirming section 1344. In a case where the strength of a signal received from an RFID tag 31b exceeds the predetermined threshold value (“YES” in S43), the individual-confirming section 1344 gives point(s) P4 to the pet corresponding to the identification information indicated by that signal (S44). In a case where the strength of a signal received from an RFID tag 31b does not exceed the predetermined threshold value (“NO” in S43), the individual-confirming section 1344 does not give points to the pet corresponding to the identification information indicated by that signal. Subsequently, the signal-strength-based identification section 1342b determines whether or not the strength of a respective signal received from each RFID tag 31b is lower than a predetermined threshold value during a predetermined period, which predetermined period is after the pet has left the animal toilet 1b. Specifically, the individual-identifying section 134b determines whether or not the strength, at the animal toilet 1b, of the respective signal received from each RFID tag 31b worn by an animal, has become less than or equal to a threshold value (second threshold value) after initially having become greater than or equal to a threshold value (first threshold value) (S45). The signal-strength-based identification section 1342b then transmits an identification result (determination result) to the individual-confirming section 1344. In a case where the strength of a signal received from an RFID tag 31b has become lower than the predetermined threshold value (“YES” in S45), the individual-confirming section 1344 gives point(s) P5 to the pet wearing the RFID tag 31b that transmitted that signal (S46). In a case where the strength of a signal received from an RFID tag 31b has not become lower than the predetermined threshold value (“NO” in S44), the individual-confirming section 1344 does not give points to the pet wearing the RFID tag 31b that transmitted that signal. The processing then proceeds to S16. Because the processing of S16 to S19 has been described in Embodiment 1, descriptions of such are omitted here.

The individual-identifying section 134b may be configured to carry out the individual identification processing exemplarily described in Embodiment 1, with use of the strength of the signal received from each RFID tag 31b. The individual-identifying section 134b may be configured to identify, from among a plurality of pets, a pet which has entered the animal toilet 1b by using any suitable combination of the individual identification processing exemplarily described in Embodiment 1 and Embodiment 3.

[Software Implementation Example]

Control blocks of the individual-identifying devices 10, 10a, and 10b (in particular, the control sections 13, 13a, and 13b) can be realized by a logic circuit (hardware) provided in an integrated circuit (IC chip) or the like or can be alternatively realized by software as executed by a central processing unit (CPU).

In the latter case, the individual-identifying devices 10, 10a, and 10b each include: a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass a “non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that an aspect of the present invention can be achieved in the form of a computer data signal in which the program is embodied via electronic transmission and which is embedded in a carrier wave.

[Recap]

An animal identifying device (individual-identifying device 10, 10a, 10b) in accordance with Aspect 1 of the present invention includes: an identity-determining information acquiring section (body-weight-based identification section 1341, signal-strength-based identification section 1342, received-signal-attenuation-based identification section 1343) which acquires at least one selected from the following: information indicating a body weight of an animal among one or more animals, as measured when that animal was in a predetermined region (animal toilet 1, 1a, 1b); and identification information that is indicated by a signal whose strength at the predetermined region is greater than or equal to a threshold value, the signal being transmitted from one of one or more transmission devices (ID information transmission device 31) respectively worn by the one or more animals; and an individual-identifying section (134) which identifies a first animal among the one or more animals which first animal has entered the predetermined region, on the basis of the at least one selected from the information indicating the body weight and the identification information.

With the above configuration, an animal which has entered the predetermined region is identified with use of at least one of a weight in the predetermined region and identification information indicated by a signal whose strength is greater than or equal to a threshold value, the signal being transmitted from an identification information worn by an animal. Therefore, even in a case where there are a plurality of animals in the vicinity of the predetermined region, it is possible to identify the animal which has entered the predetermined region.

In Aspect 2 of the present invention, the animal identifying device of Aspect 1 may be configured to further include: a detecting section (entry/exit determining section 132, 132a) configured to detect that an animal has entered the predetermined region, on the basis of at least one selected from: a change in weight measured in the predetermined region; a change in a strength of a signal transmitted from one of the one or more transmission devices; and output from a proximity sensor (16a) which is provided so as to be able to detect an animal in the predetermined region.

The above configuration makes it possible to confirm a period during which an animal is in the predetermined region, i.e., the timing of when an animal enters/exits the predetermined region. The above configuration therefore makes it possible to identify an animal that has entered the predetermined region with consideration given to the timing of entry/exit. The above configuration therefore makes it possible to identify the animal which has entered the predetermined region with a high degree of accuracy.

In Aspect 3 of the present invention, the animal identifying device of Aspect 1 or 2 may be configured such that the individual-identifying section identifies the first animal on the basis of identification information that is indicated by a signal transmitted from one of the one or more transmission devices whose strength differs, between a period during which the first animal is in the predetermined region and a period in which the first animal is not in the predetermined region, by an amount which is greater than or equal to a threshold value.

The above configuration makes it possible to identify an animal which has entered a predetermined region by, for example, comparing a weight measured in the predetermined region to the body weight of each animal. The above configuration therefore makes it possible to identify the animal which has entered the predetermined region with a high degree of accuracy.

For example, while an animal is in the predetermined region, an identification signal indicating that animal is detected as being a strong signal. In a case where that animal is not in the predetermined region, the strength of the signal is weaker. In other words, by using identification information indicated by a signal whose strength differs between a period during which an animal is in the predetermined region and a period in which an animal is not in the predetermined region, the difference being an amount which is greater than or equal to a threshold value, it is possible to identify, with a high degree of accuracy, the animal which has entered the predetermined region.

In Aspect 4 of the present invention, the animal identifying device of Aspect 1 or 2 may be configured such that: after one of the one or more animals has exited the predetermined region or before one of the one or more animals has entered the predetermined region, the identity-determining information acquiring section acquires, (i) information indicating a strength, at the predetermined region, of a signal received from the transmission device worn by that animal and (ii) the identification information indicated by that signal; the individual-identifying section carries out at least two identification processes for identifying the first animal, the at least two identification processes each making use of a differing respective piece of information selected from the following: a body weight of one of the one or more animals as measured when that animal was in the predetermined region; identification information that is indicated by a signal whose strength, at the predetermined region, is greater than or equal to a first threshold value, the signal being transmitted from one of the one or more transmission devices respectively worn by the one or more animals; identification information that is indicated by a signal whose strength, at the predetermined region, has become less than or equal to a second threshold value after initially becoming greater than or equal to the first threshold value, the signal being transmitted from one of the one or more transmission devices respectively worn by the one or more animals; identification information that is indicated by a signal whose strength, at the predetermined region, has increased by an amount greater than or equal to a third threshold value, the signal being transmitted from one of the one or more transmission devices respectively worn by the one or more animals; and identification information that is indicated by a signal whose strength, at the predetermined region, has been attenuated by an amount greater than or equal to a fourth threshold value, the signal being transmitted from one of the one or more transmission devices respectively worn by the one or more animals; and the individual-identifying section identifies the first animal in accordance with an aggregation of results of the at least two identification processes.

The above configuration makes it possible to identify an animal which has entered a predetermined region in accordance with a plurality of identification process results. The above configuration therefore makes it possible to identify the animal which has entered the predetermined region with a high degree of accuracy.

A method in accordance with Aspect 5 of the present invention is a method of controlling an animal identifying device, the method including: an identity-determining information acquisition step of acquiring at least one selected from the following: information indicating a body weight of an animal among one or more animals, as measured when that animal was in a predetermined region; and identification information that is indicated by a signal whose strength at the predetermined region is greater than or equal to a threshold value, the signal being transmitted from one of one or more transmission devices respectively worn by the one or more animals; and an individual identification step of identifying a first animal among the one or more animals which first animal has entered the predetermined region, on the basis of the at least one selected from the information indicating the body weight and the identification information. The above method brings about effects similar to those of Aspect 1 above.

The animal identifying device in accordance with each aspect of the present invention may be realized by a computer. The scope of the present invention therefore encompasses a control program for the animal identifying device which program realizes the animal identifying device in the form of a computer by causing the computer to operate as each section (software element) of the animal identifying device, and a computer-readable storage medium in which the control program is stored.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1a, 1b Animal toilet (predetermined region)
10, 10a, 10b Individual-identifying device (animal identifying device)
11 Scale
16a Proximity sensor
31 ID information transmission device
131 Weight acquiring section
132, 132a Entry/exit determining section
133 Signal strength acquiring section
134, 134b Individual-identifying section
1341 Body-weight-based identification section (identity-determining information acquiring section)
1342 Signal-strength-based identification section (identity-determining information acquiring section)
1343 Received-signal-attenuation-based identification section (identity-determining information acquiring section)

1. An animal identifying device comprising:
an identity-determining information acquiring section which acquires at least one selected from the following:
information indicating a body weight of an animal among one or more animals, as measured when that animal was in a predetermined region; and
identification information that is indicated by a signal whose strength at the predetermined region is greater than or equal to a threshold value, the signal being transmitted from one of one or more transmission devices respectively worn by the one or more animals; and
an individual-identifying section which identifies a first animal among the one or more animals which first animal has entered the predetermined region, on the basis of the at least one selected from the information indicating the body weight and the identification information.

2. The animal identifying device according to claim 1, further comprising:
a detecting section configured to detect that an animal has entered the predetermined region, on the basis of at least one selected from:
a change in weight measured in the predetermined region;
a change in a strength of a signal transmitted from one of the one or more transmission devices; and
output from a proximity sensor which is provided so as to be able to detect an animal in the predetermined region.

3. The animal identifying device according to claim 1, wherein the individual-identifying section identifies the first animal on the basis of identification information that is indicated by a signal transmitted from one of the one or more transmission devices whose strength differs, between a period during which the first animal is in the predetermined region and a period in which the first animal is not in the predetermined region, by an amount which is greater than or equal to a threshold value.

4. The animal identifying device according to claim 1, wherein:
after one of the one or more animals has exited the predetermined region or before one of the one or more animals has entered the predetermined region, the identity-determining information acquiring section acquires, (i) information indicating a strength, at the predetermined region, of a signal received from the transmission device worn by that animal and (ii) the identification information indicated by that signal;
the individual-identifying section carries out at least two identification processes for identifying the first animal, the at least two identification processes each making use of a differing respective piece of information selected from the following:
a body weight of one of the one or more animals as measured when that animal was in the predetermined region;
identification information that is indicated by a signal whose strength, at the predetermined region, is greater than or equal to a first threshold value, the signal being transmitted from one of the one or more transmission devices respectively worn by the one or more animals;
identification information that is indicated by a signal whose strength, at the predetermined region, has become less than or equal to a second threshold value after initially becoming greater than or equal to the first threshold value, the signal being transmitted from one of the one or more transmission devices respectively worn by the one or more animals;
identification information that is indicated by a signal whose strength, at the predetermined region, has increased by an amount greater than or equal to a third threshold value, the signal being transmitted from one of the one or more transmission devices respectively worn by the one or more animals; and
identification information that is indicated by a signal whose strength, at the predetermined region, has been attenuated by an amount greater than or equal to a fourth threshold value, the signal being transmitted from one of the one or more transmission devices respectively worn by the one or more animals; and
the individual-identifying section identifies the first animal in accordance with an aggregation of results of the at least two identification processes.

5. A method of controlling an animal identifying device, the method comprising:
an identity-determining information acquisition step of acquiring at least one selected from the following:
information indicating a body weight of an animal among one or more animals, as measured when that animal was in a predetermined region; and
identification information that is indicated by a signal whose strength at the predetermined region is greater than or equal to a threshold value, the signal being transmitted from one of one or more transmission devices respectively worn by the one or more animals; and
an individual identification step of identifying a first animal among the one or more animals which first animal has entered the predetermined region, on the basis of the at least one selected from the information indicating the body weight and the identification information.

6. A non-transitory computer-readable storage medium storing a program for causing a computer to function as an animal identifying device recited in claim 1, the program causing the computer to function as the identity-determining information acquiring section and the individual-identifying section.
